(19) United States
(12) Patent Application Publication
(10) Pub. No.: US 2026/0166807 A1
(43) Pub. Date: Jun. 18, 2026

(54) SYSTEMS AND METHODS FOR VOLUMETRIC SUBTRACTIVE MANUFACTURING AND HYBRID VOLUMETRIC ADDITIVE/SUBTRACTIVE MANUFACTURING

(71) Applicant: Lawrence Livermore National Security, LLC, Livermore, CA (US)

(72) Inventors: Dongping TERREL-PEREZ, Livermore, CA (US); Magi Mettry Yassa, Antioch, CA (US); Martin Patrick De Beer, Berkeley, CA (US); Maxim Shusteff, Piedmont, CA (US); Sijia Huang, Dublin, CA (US); Benjamin Martin Alameda, Livermore, CA (US); Erika Jo Fong, San Ramon, CA (US); Johanna Jesse Schwartz, Las Vegas, NV (US)

(73) Assignee: Lawrence Livermore National Security, LLC, Livermore, CA (US)

(21) Appl. No.: 18/978,297

(22) Filed: Dec. 12, 2024

(51) Int. Cl. B29C 64/129; B29C 64/264; B33Y 10/00; B33Y 30/00

(52) U.S. Cl. CPC B29C 64/129; B29C 64/264; B33Y 10/00; B33Y 30/00

(57) ABSTRACT

The present disclosure relates to a volumetric subtractive manufacturing system. In one embodiment the system uses a quantity of a material susceptible to received light at a first wavelength to alter a characteristic of the material. An optical light source is configured to project a light beam into a container that contains the quantity of material. The light beam is projected using the first wavelength, to alter the characteristic of the material. Altering a characteristic of the material forms a feature within the material.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to additive manufacturing systems and methods, and more particularly to new systems and methods well suited for forming small negative features within a larger volume of material using a photo-degradable material.

### BACKGROUND

The statements in this section merely provide background information related to the present disclosure and may not constitute prior art.

Tomographic volumetric additive manufacturing (VAM) has revolutionized light-driven additive manufacturing (“AM”) processes. By projecting tomographically patterned light into a rotating vial filled with photo-polymer resin materials, the resin is selectively polymerized and a 3D structure is formed, all-at-once, within seconds. This ability expands the geometric freedom and material scope accessible, achieving fully printed end use objects quickly. However, VAM still suffers from overcuring and diffusion, which is more detrimental in small negative feature fabrication. Moreover, curing the vast majority of a quantity of material volume in order to form a small channel inside the material volume will cause a huge refractive index change, which dramatically distorts the print light. The achievable smallest resolution and fidelity of a negative feature is always worse than the smallest positive one. All-in-all, due to the additive nature of AM methods, these methods are inherently not suitable for negative feature fabrication. Thus, present day VAM processes are not well suited to applications with extensive negative features, for example microfluidics and vascular structures.

Accordingly, new systems and methods are needed when using an AM printing process to manufacture small negative features within a 3D part, which do not suffer from the drawbacks of a large refractive index change being created, and which are not as susceptible to overcuring and diffusion.

### SUMMARY

This section provides a general summary of the disclosure, and is not a comprehensive disclosure of its full scope or all of its features.

In one aspect the present disclosure relates to a volumetric subtractive manufacturing system for use with a quantity of material held in a container, the quantity of material being responsive to received light at a first wavelength, which alters a characteristic of the material. The system may comprise a control system for supplying information pertaining to at least one image needed to form a part from the quantity of material or a feature on or within the quantity of material. The system may also comprise an optical light source configured to project a light beam carrying the at least one image into the container at the first wavelength, to alter the characteristic of the material. The altering a characteristic of the material forms the part or the feature.

In another aspect the present disclosure relates to a hybrid volumetric additive and subtractive manufacturing system for forming a structure or part using a container, wherein the container holds a quantity of a dual functionality material, wherein the dual functionality material is contained within the container and is susceptible to light at a first wavelength to photo-polymerize the dual functionality material, and also to light of a second wavelength which degrades the dual functionality after the dual functionality material has been polymerized to turn the dual functionality material to a liquid. The system may comprise a rotational stage for supporting the container and rotating the container to a plurality of different angular positions. The system may also comprise an optical light source subsystem configured to project a series of first images formed by first light beams into the container at the first wavelength as the container is rotated to the different angular positions, to provide a cumulative optical exposure dose sufficient polymerize the dual functionality material to form a first structure. The optical light source is further configured to project a series of second images formed by second light beams into the container at the second wavelength as the container is rotated to the different angular positions, to provide a cumulative optical exposure dose sufficient to photo-degrade select portions of the polymerized material. This causes the photo-degraded portions to turn to liquid and flow away from the first structure to form a second structure. The second structure forms a final 3D part, or represents the first structure having one or more new features.

In still another aspect the present disclosure relates to a method for performing volumetric subtractive manufacturing. The method may comprise providing a quantity of a material susceptible to light at a first wavelength to alter a characteristic of the first material. The method may also involve projecting an image carried by a light beam into the quantity of material at the first wavelength to provide an optical exposure dose sufficient alter the characteristic of the material. The altering a characteristic of the material includes turning a portion of the material from a solid state into a liquid state. This forms at least one of a 3D part from the quantity of material, wherein the 3D part is related to the image, or a feature on or within the quantity of material, wherein the feature is related to the image.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a high level block diagram of one example of a system and method in accordance with the present disclosure which is well suited for volumetric AM printing small negative features within a volume of resin;

FIG. 2 is an image of an part printed in accordance with the present disclosure showing a void space created within a larger volume of material;

FIG. 3 is a high level flowchart showing one example of basic operations that may be carried out in accordance with the methodology of the present disclosure to create a 3D part with a small feature within a larger volume of material; and

FIG. 4 is a high level flowchart showing various operations that may be performed in carrying out one implementation of the present disclosure.

### DETAILED DESCRIPTION

Example embodiments will now be described more fully with reference to the accompanying drawings.

The present disclosure overcomes the above-described limitations and drawbacks of AM printing system through new systems and methods which may be termed “volumetric subtractive manufacturing” (“VSM”). With VSM, instead of just the absence of positive features as all additive manufacturing methods do, the negative features are actively printed. In other words, the negative space is the feature of interest to print.

With VSM, tomographically patterned light of the negative features of interest is projected into a rotating vial, which is filled with photo-degradable material. During print, the material in negative space receives enough accumulated light energy to degrade, for example but not limited to, into liquid form, which can then be removed in solvents or by other means, for example and without limitation, by spinning or centrifuging. This results in negative features of interest. As such, the negative features are “actively” printed using the new systems and methods described herein.

One can also achieve hybrid volumetric additive/subtractive manufacturing by using photo-selective resin materials: the resin will polymerize under illumination of light with one wavelength λ1, and degrade under illumination of light with another wavelength λ2. One can first print a 3D structure by polymerizing resin materials using VAM approach with λ1 illumination, and then subsequently remove some parts by degrading polymer materials using VSM approach with λ2 illumination.

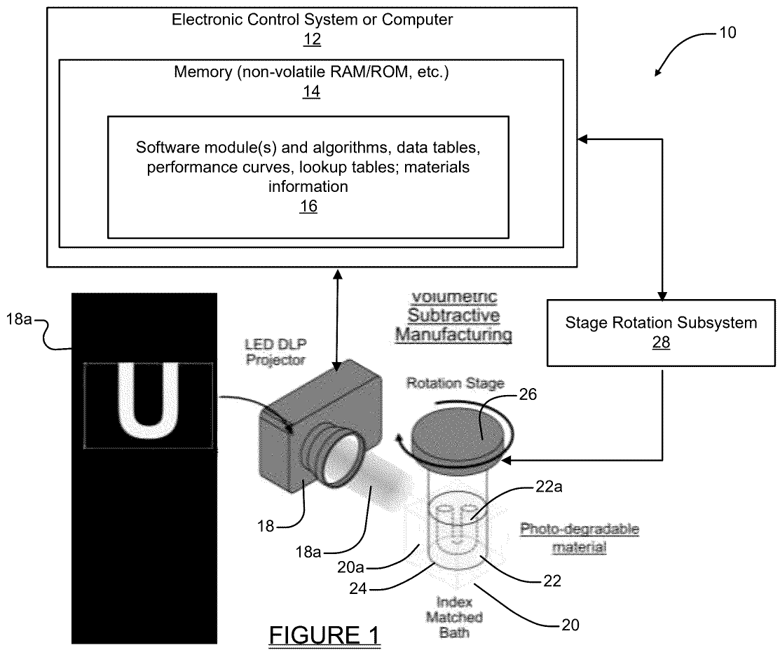

Referring to FIG. 1, one example of a system 10 in accordance with the present disclosure is shown. In this example the system 10 may include an electronic control system or computer 12 (hereinafter simply “ECS 12”). The ECS 12 may have a memory 14, or the memory 14 may be external to the ECS 12. The memory 14 may be non-volatile memory (e.g., RAM/ROM/DRAM, etc.) which stores one or more software modules 16 and/or algorithms, data tables, performance curves, lookup tables, materials information databases, etc., which are helpful or needed in manufacturing a 3D part.

The ECS 12 may be in communication with a light generating component 18. In one embodiment the light generating component is a digital light processing projector, which will hereinafter be referred to as “DLP projector 18”. It will be appreciated that other optical sources could be used as well, for example and without limitation, static masks, LED/LCD projectors, rastering lasers, and/or film projectors. As such, the present disclosure is not limited to use with only the DLP projector 18. The DLP projector 18 projects a series of 2D light images 18a into a quantity of photo-degradable material 22 disposed within a container 24. The container 24 may be positioned within an outer container 20 holding a material 20a which is index matched to the photo-degradable material 22. The 2D images are synchronized in accordance with rotation of the container 24 via a rotation stage 26 which supports the container 24. In one embodiment the rotation stage 26 is driven rotationally by a stage rotation subsystem 28. In other embodiments the material container 24 may be held stationary and the DLP projector 18 may be rotated. In some implementations a plurality of stationary DLP projectors may be arranged around the material container 24, and the material container may be held stationary while a plurality of 2D or 3D images are projected into the material container 24, either sequentially or simultaneously, to provide the needed cumulative exposure dose to selectively polymerize and/or degrade material inside the material container 24.

The stage rotation subsystem 28 may container one or more DC; stepper motors and/or linear actuators or other components needed to drive rotation stage 26 to preselected different angular positions. In some embodiments the stage rotation subsystem 28 may be controlled in response to control signals received from the ECS 12, and in some embodiments the subsystem 26 may have its own controller. In some embodiments the ECS 12 may also control the DLP projector 18 such that a plurality of 2D images are sequentially projected at various predetermined rotation intervals, for example every 5-10 degrees, into the container 24, as the container is rotated, momentarily stopped, then rotated to a new angular position, stopped, etc. In this regard, it will be appreciated that systems and methods for generating 2D images for such a system are disclosed in U.S. Pat. No. 10,647,061 B2 to Kelly et al., issued May 12, 2020, and which is assigned to the assignee of the present application, and which is hereby incorporated by reference into the present application.

As each 2D image is projected in the material 20 and the photo-degradable material, a cumulative exposure dose builds up in the photo-degradable material 22 which ultimately becomes sufficient to degrade only select portions of the photo-degradable material, but which does not reach sufficient energy to degrade the surrounding material which envelops it. The now degraded photo-degradable material 22 may be removed, such as by simply draining it out if a channel has been formed via the photo degradable material 20a, or via solvents, or via spinning or centrifuging, or in some instances may not need to be removed. This leaves the resulting U-shaped channel 22a, which forms a negative feature, as shown in FIG. 1. In some embodiments the surrounding material may be nanoporous, so the now liquid state photo-degradable material 22 may simply drain out through the pores of the surrounding material portion. In some embodiments a syringe with a fine needle may be used to remove by suction force the photo-degradable material 22 if it is in a liquid state. These are but a few examples, and other means or methods may be used to remove the photo-degradable material 22 when it is in liquid form. In some embodiments where only a single wavelength is light is able to be projected, then one may start with a solid block of optically degradable material, and then controllably, optically degrade that/those portion/portions of it that one does not want, to produce the negative feature(s).

In some embodiments the photo-degradable material may be a positive photoresist formulation (e.g., and without limitation, PMMA, DQN-novolac, etc.). In some embodiments a dual functionality resin may utilized which polymerizes in response to a sufficient dose of optical energy having a first wavelength, but which degrades to form a liquid when exposed to a sufficient dose of optical energy at a second wavelength. One such example of a resin is disclosed in U.S. application Ser. No. 63/656,502 filed Jun. 5, 2024, the entire disclosure of which is hereby incorporated by reference into the present application. In summary, however, the dual functionality resin may be a photopolymer resin capable of polymerization by exposure to polymerizing light, which is light having a wavelength (or wavelengths) in a first range, with the added capability of depolymerization of a resulting polymer product by exposure to depolymerizing light, which is light having a wavelength (or wavelengths) in a second range. The photoselectivity of both processes allows for deliberate and spatially accurate control for adding and removing polymer material.

In one approach, a photopolymer resin forming the dual functionality resin may be a formulation which includes (1) one or more pH labile monomers that include polymerizable functional handles such as one or more acrylates, one or more methacrylates, one or more alkenes, one or more thiols, and/or one or more epoxies; (2) a photoinitiator sensitive to polymerizing light, e.g., visible light; (3) a photoacid or photobase generator responsive to depolymerizing light, e.g., UV light; and optionally, (4) one or more other additives such as reactive diluents, unreactive diluents, pH stabilizers, etc.

The pH labile monomer may be any suitable pH labile monomer. In some approaches, the pH labile monomer(s) are of a type known in the art to form polymers that are pH labile, meaning the polymer disintegrates, at least to some extent, in the presence of acidic and/or basic conditions. Further details of a suitable pH labile monomer as mentioned above are disclosed in “Hydrolytically degradable poly (β-thioether ester ketal) thermosets via radical-mediated thiol-ene photopolymerization”, B. Alameda, et al., Polym. Chem, 2019 10.5635, and “Hydrolyzable Poly (β-thioether ester ketal) Thermosets via Acyclic Ketal Monomers”, B. Alameda et al., Macro-Molecular Rapid Communications, 2022, which are both incorporated by reference into the present disclosure.

One general class of pH labile monomers includes those with a ketal group that is pH labile, and polymerizable functional handles (also referred to herein a crosslinkers), such as the aforementioned acrylates, methacrylates, alkenes, thiols, and/or epoxies. In one approach, this monomer occupies up to about 48% by weight of the formulation. Examples of crosslinkers include vinyl, acrylate, urea, or other crosslinkers that will create a polymer in the presence of an initiator upon activation. Other classes of pH labile monomers may be based on functional groups (other than ketal) that are known to be pH labile, along with the polymerizable functional handles. Two examples of pH labile monomers are dibenzo[c,e]-oxepane-5-thione (DOT) and 2-methylene-1,3-dioxepane (MDO), both of which cleave under basic conditions.

In some approaches, the pH labile monomer includes a dialkene ketal monomer.

In some approaches, the pH labile monomer includes a bisalkene diketal monomer configured to polymerize into a poly(β-thioether ester ketal) network that is degradable, and in some cases, completely degradable under acidic or basic conditions. In some approaches, the bisalkene diketal monomers may be bisalkene diketal monomers with a mercaptopropionate-based trifunctional thiol.

For example, degradable poly(/3-thioether ester ketal) networks may be formed via thiol-ene photopolymerization using bis-allyl acyclic ketal monomers derived from acetone, cyclopentanone, or cyclohexanone.

One or more additional monomers may be present in the resin, to polymerize with the pH labile monomer. Examples include thiols such as ETTMP 1300 sold by Bruno Bock having a sales office at Glenpointe Center West 4 Floor 500 Frank W. Burr Boulevard, Teaneck, NJ 07666. Pentaerythritol tetrakis(3-mercaptopropionate) (PETMP) and trimethylolpropane diallyl ether are two additional examples of monomers to be polymerized with pH labile monomers.

In one approach, the pH labile monomer is BMA L007 and the thiol is PETMP, shown below. The SH group of the PETMP and the double bonded crosslinker of the BMA L007 form a thermoset that bond during curing. The pH labile functional group of BMA L007 is the oxygen-cycle ketal portion, while the double bonded atoms at the ends are the crosslinkers.

The photoinitiator may be any known photoinitiator based on the desired wavelength of polymerizing light, to cause polymerization of the resin upon exposure of the resin to polymerizing light.

In various approaches, the photoinitiator may be Darocur 1173 or the like. Darocur 1173 is available from Ciba. Other examples of visible light photoinitiators include Diphenyl(2,4,6-trimethylbenzoyl)phosphine oxide (TPO), available from Sigma-Aldrich; Phenylbis(2,4,6-trimethylbenzoyl)phosphine oxide (BAPO) (0.1-1%), available from Sigma-Aldrich; and Irgacure 784, available from Ciba.

In various approaches, the photoinitiator may be a photoinitiator created from camphorquinone and ethyl 4-(dimethylamino)benzoate, shown below. The resulting photoinitiator is active at light at about 455 nm.

The photoacid or photobase generator may be any known photoacid or photobase generator that is responsive to the desired wavelength of depolymerizing light to form an acid or a base upon exposure to the depolymerizing light.

In one approach, the photoinitiator is activated by visible light, preferably blue light in the visible spectrum, while the photoacid or photobase generator is activated by UV light. When irradiated with UV light, the photoacid generator releases free acid in the polymer, which can react with the pH labile species and degrade the thermoset network. In another approach, the photoinitiator is activated by UV light, while the photoacid or photobase generator is activated by visible light.

In one approach, triarylsulfornium hexafluoroantimonate may be used as a photoacid generator, which creates acid when exposed to UV light at 365 nm. This is typically used at 0.5-5% weight percent in the resin to achieve the desired effect. 4-[(2-hydroxytetradecyl)oxy]phenyl] phenyliodonium hexafluoroantimonate (HOPH) and diphenyliodonium hexafluorophosphate (DPI) are other examples of photoacid generators that may be used in the formulation.

The one or more other additives may include any known additive added to provide a desired function or property. Examples include reactive diluents, unreactive diluents, pH stabilizers, etc.

In one approach, ethanol may be added to assist in the distribution of the acid from photoacid generator to the pH labile moieties. In one approach, ethanol is used in the formulation at about 5 -15 weight percent. Another similar chemical that could be used in place of ethanol is propylene glycol, which would achieve the same function.

In another approach, pyridine may be added to function as a quencher (acid inhibitor) so that the acid produced does not continue to degrade the polymer much beyond the portion desired to be disintegrated. This in turn enables selective degradation with higher spatial resolution. In one approach, pyridine is used in the formulation at about 0.05-0.5 weight percent. Another example of an alternative base is quinoline, another organic base.

The components (1)-(3), and optionally (4) of the resin should be present in an effective amount to provide the desired characteristic, property and/or functionality. Illustrative amounts of the various components by wt % relative to the total weight of the resin are as follows: >0 to about 5 wt % photoinitiator, 0.01 to about 3 wt % photoacid generator or photobase generator, 0 to about 15 wt % additive(s), and the remainder monomer(s) (e.g., pH labile monomer(s) and any comonomer(s)). Some approaches may have higher concentrations than those shown here. Moreover, if the photoacid generator concentration in the polymer product is too low, the degradation may be partial, resulting in a partial depolymerization, e.g., the polymer product remains solid but is weakened.

The use of such a dual functionality resin enables forming a 3D part in a “negative” fashion where the process starts by polymerizing a quantity of the dual functionality resin using a first wavelength optical signal (or any other method to cause polymerization), and then portions thereof are selectively degraded by applying a cumulative dose of optical energy at a second wavelength which causes the needed material degradation. This turns portions of the polymerized resin to a liquid, which simply drain away, leaving only the desired 3D part left. So in this instance the 3D part is formed in a fully “negative” fashion by removing those portions of the polymerized resin that are not needed to form the final 3D part.

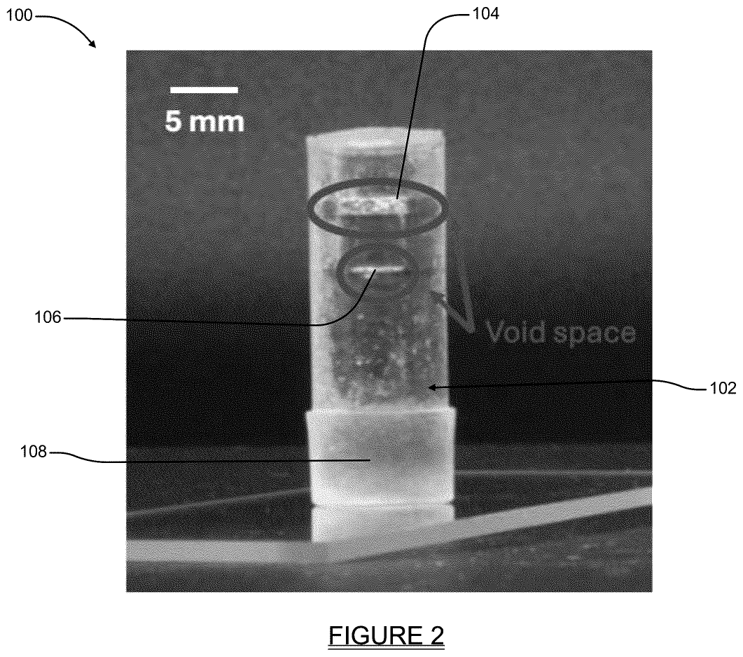

FIG. 2 shows an image 100 of an actual product or part 102 formed using the system and method described above. In this example void spaces 104 and 106 are formed within a large 3D volume of solid material 108.

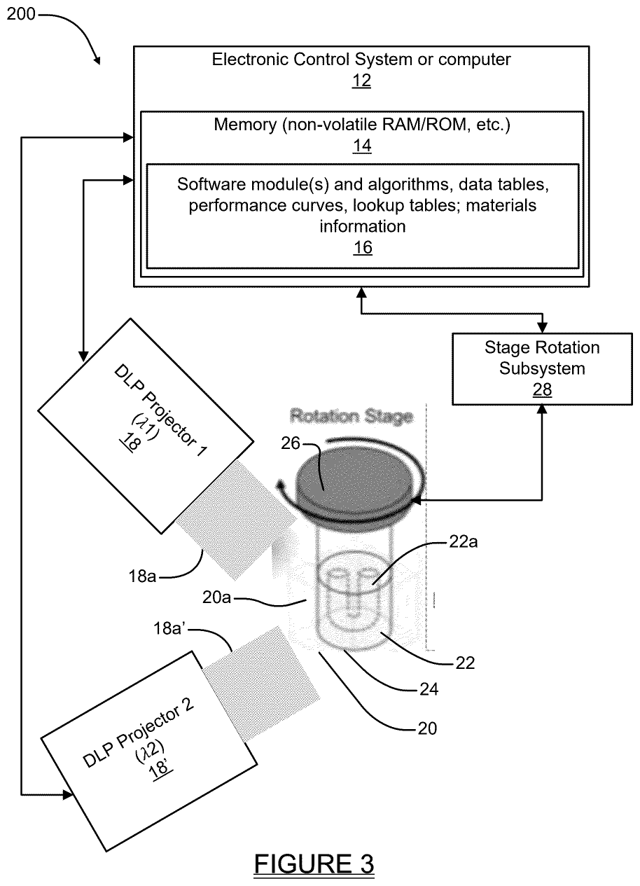

Referring to FIG. 3, the systems and methods of the present disclosure can also be used to construct a hybrid volumetric additive/subtractive manufacturing system 200 and methodology by using a dual functionality resin as described above. In this example, the resin will polymerize when exposed to an optical signal 18a which provides a sufficient dosage of optical energy at a first wavelength λ1 from first DLP projector 18, and thus will solidify to form a solid structure. The polymerized resin 22 will degrade, however, when exposed to light 18b with a second wavelength λ2 from the second DLP projector 18′. One can thus print a 3D structure by initially using the first DLP projector 18 to polymerize the resin by projecting a first set of tomographically patterned light fields (i.e., using light 18a) with λ1 wavelength light illumination into the container 24. The cumulative exposure dose of L1 wavelength light 18a received by the material 20 as the container is rotated to different angular positions polymerizes the dual functionality resin 22 to form the solid structure. The second DLP projector 18′ may then be used to project a different set of tomographically patterned light fields (i.e., using light 18a′) into the container 24, at different angles around the container. This causes a cumulative exposure dose to build up in select portions of the polymerized resin which degrades the select portions of the polymerized resin, thus causing them to turn to liquid and flow away, leaving only the finished 3D part in solid form. This is forming the complete 3D part in negative fashion by removing portions of the polymerized resin not needed for it.

It will be appreciated that in some implementations a single DLP projector, or other optical signal source, could be used which alternates projecting the needed optical signals to act on both the material 22. In other words, to alternately project a light beam having the L1 wavelength and then the L2 wavelength, at each angular position of the container 24, at a high frequency such that it appears that the two optical signals of different wavelengths are being projected simultaneously. With such a configuration, the two DLP projectors 18 and 18′ may be replaced with a single “multi-wavelength, DLP projector subsystem”.

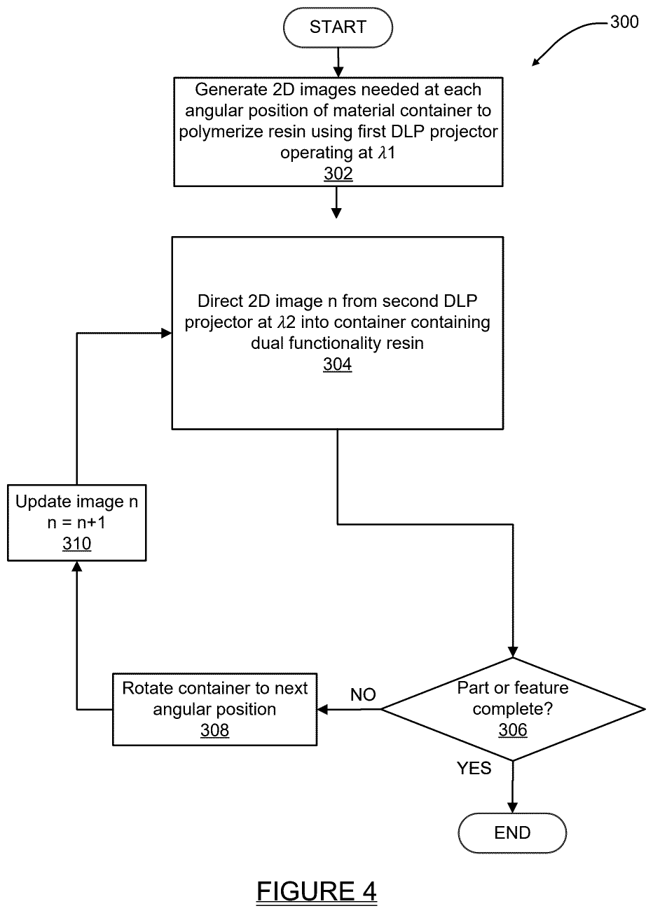

FIG. 4 shows a flowchart 300 in accordance with one high level example of various operations that may be performed using the system 10 to implement a manufacturing operation as described for the system of FIG. 3 that makes use of a dual functionality resin. At operation 302 the 2D images needed at each angular position of the container are generated using the DLP projector 18 to generate an optical signal 18a at λ1 to polymerize the dual functionality resin held in the container 24. At operation 304 the controlled degradation process begins by projecting a first 2D image from the DLP second projector 18′ at λ2 into the container 24 containing the dual functionality resin when the container is in a first angular position. At operation 306 a check is made (e.g., by ECS 12) if the 3D part is complete. If not, then the container 24 is rotated to the next predefined angular position, as indicated at operation 308. Operations 304-310 are repeated until all of the 2D images needed to degrade the dual functionality resin have been projected, which will have caused all of the undesired resin portions to turn to liquid and drain away, leaving only the final finished 3D part, and/or the finished part with its negative feature fully formed. When the check at operation 308 produces a “Yes” answer, then the printing process is complete. The finished part may be subjected to other manufacturing processes depending on the type of part being formed and its intended use. If a resin other than a dual functionality resin is being used, then the process is essentially the same, but will start with a solid block of material, so operation 302 will not need to be performed. Operations 304-310 would still be performed to form the 3D part and/or its negative feature.

It will also be appreciated that while the use of two distinct wavelength optical signals has been described for processing dual functionality resin, that the present disclosure may in some implementations be used with three or more distinct wavelength optical signal sources (e.g., three separate DLP projectors operating to generate different wavelength optical beams) that act to independently process or act on three different distinct, optically responsive materials. Still further, in some implementations the system 10 could be configured such that polymerization or degradation involves using a photoswitchable initiator (e.g., https://www.nature.com/articles/s41586-020-3029-7) or possibly even a photoswitchable photoacid to degrade the material), in combination with one other wavelength, which would effectively be a three wavelength system.

The embodiments and methods described herein are expected to find utility in forming a wide variety of parts and components for use in widely diverse technologies and applications, and also where small negative features within the overall structure or part are needed. Such technologies and applications are expected to include, without limitation, microfluidics and bio applications involving vascular structures.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A volumetric subtractive manufacturing system for use with a quantity of material held in a container, the quantity of material being responsive to received light at a first wavelength, which alters a characteristic of the material, the system comprising:
a control system for supplying information pertaining to at least one image needed to form a part from the quantity of material or a feature on or within the quantity of material;
an optical light source configured to project a light beam carrying the at least one image into the container at the first wavelength, to alter the characteristic of the material; and
wherein the altering a characteristic of the material forms the part or the feature.

2. The system of claim 1, wherein the feature comprises a negative feature.

3. The system of claim 1, wherein the light beam carrying the at least one image comprises a 2D optical image.

4. The system of claim 1, further comprising a container for containing the quantity of material, and a rotationally supported stage for supporting the container and controllably rotating the container to different angular positions.

5. The system of claim 4, wherein the optical light source sequentially projects a plurality of 2D images, each one of the 2D images being projected at a different angular position of the container, to form a tomographic 3D image which selectively degrades the quantity of material to form the feature.

6. The system of claim 1, wherein the first wavelength is operable to cause a degradation of the material, to change a state of the material from a solid to a liquid.

7. The system of claim 1, wherein the optical light source comprises a digital light processing (DLP) projector.

8. The system of claim 1, wherein the control system comprises an electronic control system for at least partially controlling the optical light source.

9. The system of claim 4, further comprising a stage rotation subsystem for rotating the rotationally supported stage.

10. The system of claim 9, further comprising an electronic control system for at least partially controlling the stage rotation subsystem to thus help control rotational movement of the rotationally supported stage.

11. The system of claim 4, further comprising an additional container having an additional quantity of resin, within which the container is disposed, and wherein an index of refraction of the quantity of material is matched with an index of refraction of the additional quantity of resin.

12. The system of claim 1, wherein the optical light source is configured to project an additional light beam into the quantity of material at a second wavelength to photo-polymerize the quantity material before exposing the material to the light at the first wavelength.

13. A hybrid volumetric additive and subtractive manufacturing system for forming a structure or part using a container, wherein the container holds a quantity of a dual functionality material, wherein the dual functionality material is contained within the container and is susceptible to light at a first wavelength to photo-polymerize the dual functionality material, and also to light of a second wavelength which degrades the dual functionality material to turn the dual functionality material to a liquid, the system comprising:
a rotational stage for supporting the container and rotating the container to a plurality of different angular positions;
an optical light source subsystem configured:
to project a series of first images formed by first light beams into the container at the first wavelength as the container is rotated to the different angular positions, to provide a cumulative optical exposure dose sufficient polymerize the dual functionality material to form a first structure; and
to project a series of second images formed by second light beams into the container at the second wavelength as the container is rotated to the different angular positions, to provide a cumulative optical exposure dose sufficient to photo-degrade select portions of the polymerized material to cause the photo-degraded portions to turn to liquid and flow away from the first structure to form a second structure, wherein the second structure forms a final 3D part, or represents the first structure having one or more new features.

14. The system of claim 13, wherein the optical light source subsystem comprises a first digital light processing projector for generating the first light beam and an independent second digital light processing projector for generating the second light beam.

15. The system of claim 14, further comprising a rotational stage for supporting the container.

16. The system of claim 14, further comprising an electronic control system configured to control at least one of the first or second digital light processing projectors.

17. The system of claim 16, wherein the electronic control system also controls rotation of the rotational stage.

18. A method for performing volumetric subtractive manufacturing, the method comprising:
providing a quantity of a material susceptible to light at a first wavelength to alter a characteristic of the first material;
projecting an image carried by a light beam into the quantity of material at the first wavelength to provide an optical exposure dose sufficient alter the characteristic of the material, wherein the altering a characteristic of the material includes turning a portion of the material from a solid state into a liquid state, to thus form at least one of:
a 3D part from the quantity of material, wherein the 3D part is related to the image, or
a feature on or within the quantity of material, wherein the feature is related to the image.

19. The method of claim 18, wherein projecting a light beam into the container comprises projecting a series of 2D images into the container through a plurality of light beams as the container is rotated to different angular positions, to provide a cumulative optical exposure dose sufficient to alter the characteristic of the quantity of material.

20. The method of claim 18, wherein the quantity of material forms a quantity of photo-responsive resin in liquid form held within a container, which is polymerizable at a second wavelength; and
polymerizing the quantity of photo-responsive resin using at least one image carried by an additional beam of light, before applying the light beam at the first wavelength to form at least one of the 3D part or a feature on or within the quantity of material.
